(19) United States
(12) Patent Application Publication
(10) Pub. No.: US 2006/0055167 A1
(43) Pub. Date: Mar. 16, 2006

(54) Sheet retaining devices such as binders having pockets with corner locks

(76) Inventors: Russell D. Pollman, Fullerton, CA (US); Christine K. Hibberd, Irvine, CA (US); Elizabeth M. Sanchez, Glendale, CA (US); Heather A. Gareis, Los Angeles, CA (US); Conrad Traut, Sharon, MA (US); Brian W. King, New Albany, OH (US); Ronald Ugolick, San Dimas, CA (US)

Correspondence Address: Eric K. Satermo, P.O. Box 19099, Irvine, CA, 92623-9099, US

(21) Appl. No.: 11/174,004

(22) Filed: Jun. 30, 2005

Related U.S. Application Data
(60) Provisional application No. 60/584,633, filed on Jun. 30, 2004.

(51) Int. Cl. B42D 1/00

(52) U.S. Cl. 281/21.1

(57) ABSTRACT

A sheet retaining device such as a folder or a binder that incorporates a corner lock for preventing papers from dislodging therefrom. The sheet retaining device has a front cover and a back cover. Each of the covers has a top edge, a bottom edge, an outer edge, and an inner edge. A first primary flap is connected to the back cover along the outer edge and the bottom edge thereof to form a pocket that is adapted to receive one or more pieces of sheet material. A secondary flap is connected to the back cover along the inner edge and the top edge thereof to form a corner lock adapted to retain corner of sheet material retained in the sleeves. Accordingly, when a piece of sheet material is retained in the pocket, the secondary flap acts as a corner lock on the free corner of the sheet material, tending to retain this free corner and the sheet material in the pocket, even if the sheet retaining device is turned upside down or sideways.

### CROSS REFERENCE TO RELATED APPLICATIONS

The present application claims priority on U.S. Provisional Application for Patent Ser. No. 60/584,633 filed Jun. 30, 2004, the entire disclosure of which is incorporated herein by reference.

### BACKGROUND OF THE INVENTION

The invention relates to binders and other sheet retaining devices such as sheet protectors with pockets for holding sheet material such as paper documents or the like.

Conventional sheet retaining devices such as sheet protectors, binders, and folders typically include a sleeve or pocket in which one or more pieces of sheet material may be received. These pockets or sleeves include a flap that can be folded back to insert the piece of sheet material. As shown in U.S. Pat. No. 6,874,968, one conventional document holder does have two triangular pockets but no overlying sheet to protect the face of the document. The pockets are next to each other, at the opposite ends of one edge of the document. Published U.S. Patent Application No. 2004/0066031 A1 shows a cover with each inside surface having a pocket underneath a corner tab. While this cover does hold a sheet, the direction of insertion or removal of the document is constrained by the rectangular pocket. One of the drawbacks of such conventional devices may be that if the device is turned upside down or sideways, there is a risk that the sheet material can dislodge from the pocket. Alternatively, the direction of insertion or removal of the document may be constrained by the pocket configuration.

Accordingly, there is a continued desire for sheet retaining devices that prevent the inadvertent dislodging of sheet material from therein or that facilitate the insertion of a sheet from more than one direction. The present invention satisfies one or more of these needs.

### SUMMARY OF THE INVENTION

The invention relates to binders and other sheet retaining devices such as sheet protectors with pockets for holding sheet material such as paper documents or the like.

According to one aspect of the invention, and by way of example only, a sheet retaining device such as a folder or a binder includes a front cover and a back cover. Each of the covers has a top edge, a bottom edge, an outer edge, and an inner edge. A first primary flap is connected to the back cover along the outer edge and the bottom edge thereof to form a pocket that is adapted to receive one or more pieces of sheet material. A secondary flap is connected to the back cover along the inner edge and the top edge thereof to form a corner lock that is adapted to retain corner of sheet material retained in the sleeves. Accordingly, when a piece of sheet material is retained in the pocket, the secondary flap acts as a “corner lock” on the free corner of the sheet material, retaining this free corner and retaining the sheet material in the pocket, even if the sheet retaining device is turned upside down or sideways.

According to another aspect of the invention, a second primary flap may be connected to the back cover along the outer edge and the bottom edge and positioned between the first primary flap and the back cover to form a pair of sleeves each adapted to retain a piece of sheet material. Accordingly, each of the sleeves may retain sheet material with the free corners of the sheet material being retained by the secondary flap.

In binder embodiments, the sheet retaining device may include a spine disposed between the covers, and a binding mechanism may be disposed at or near the spine. The principles of the sheet retaining device are also applicable to folders and other similar stationery products.

Other features and advantages of the present invention will become apparent to those skilled in the art from a consideration of the following detailed description taken in conjunction with the accompanying drawings.

### BRIEF DESCRIPTION OF THE SEVERAL VIEWS OF THE DRAWINGS

FIG. 1 is a perspective view of a binder according to one of the embodiments;

FIG. 2 is a plan view of the inside of the binder;

FIG. 2A is an enlarged fragmentary plan view of a secondary corner lock of a sheet retaining device;

FIG. 2B is an enlarged fragmentary plan view of a secondary corner lock of a sheet retaining device;

FIG. 2C is an enlarged fragmentary plan view of an alternative secondary corner lock of a sheet retaining device;

FIG. 2D is a cross-sectional view taken along line 2D-2D of FIG. 2;

FIG. 3 is a detailed plan view of an inside of a binder according to a specific embodiment;

FIG. 4 illustrates a sheet protector with a corner lock;

FIG. 5 is a cross-sectional view taken along line 5-5 of FIG. 4;

FIG. 6 is a plan view of another sheet protector with a corner lock;

FIG. 7 is a plan view of the sheet protector of FIG. 6 with a cover sheet folded away;

FIG. 8 is a plan view of a folder with a pair of corner locks;

FIG. 9 is a cross-sectional view taken along line 9-9 of FIG. 8; and

FIGS. 10A to 10F illustrate methodology for manufacturing a sheet retaining device according to a number of embodiments.

### DETAILED DESCRIPTION OF THE INVENTION

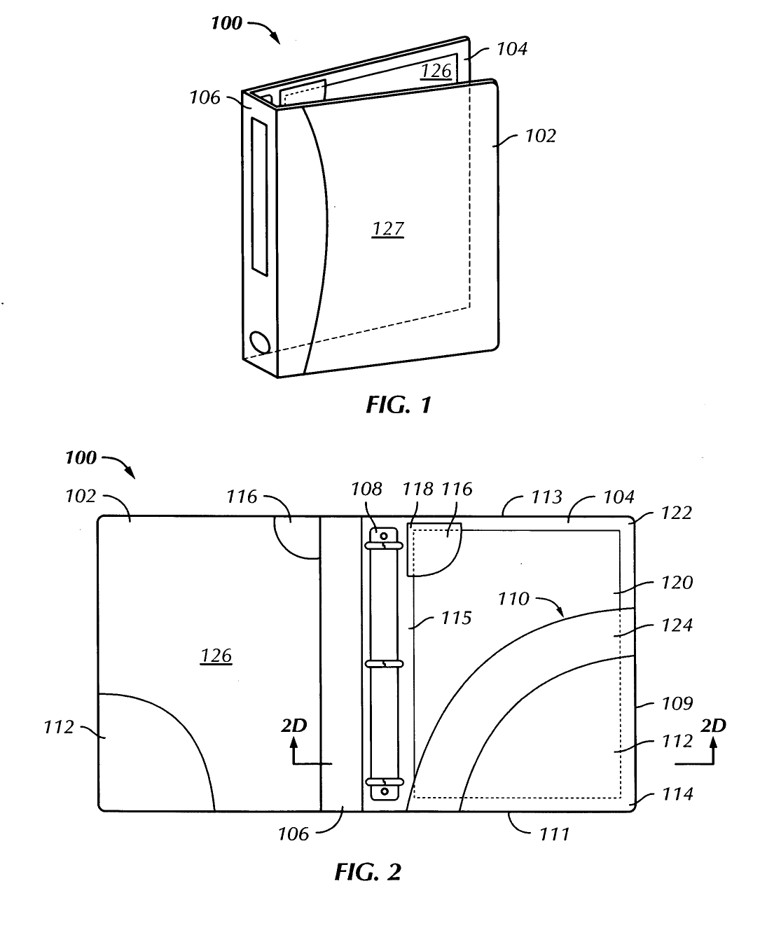

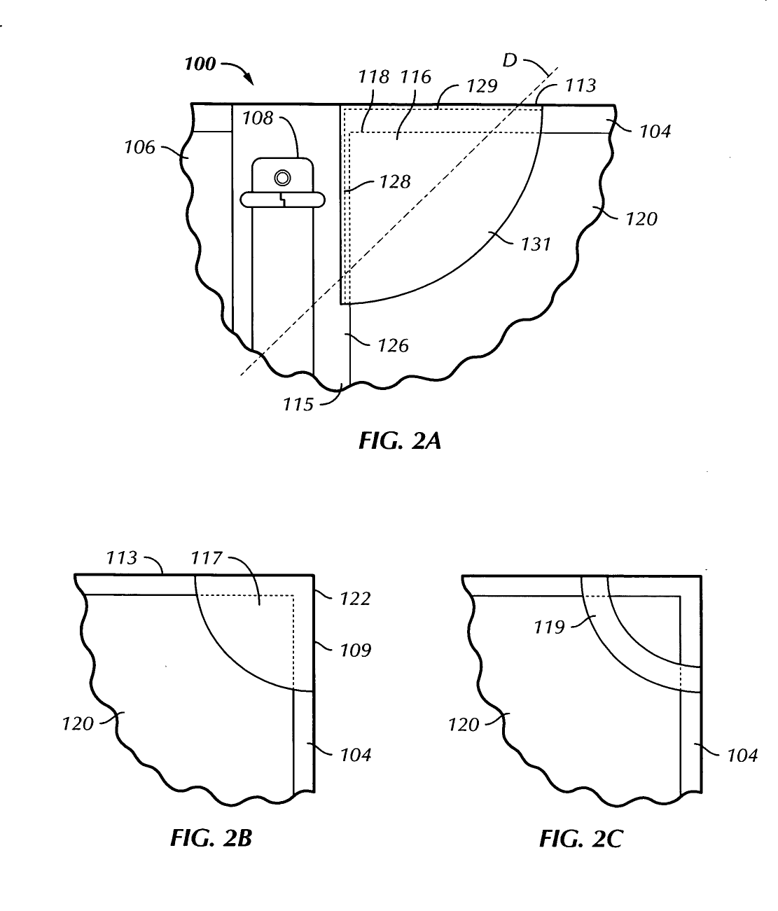

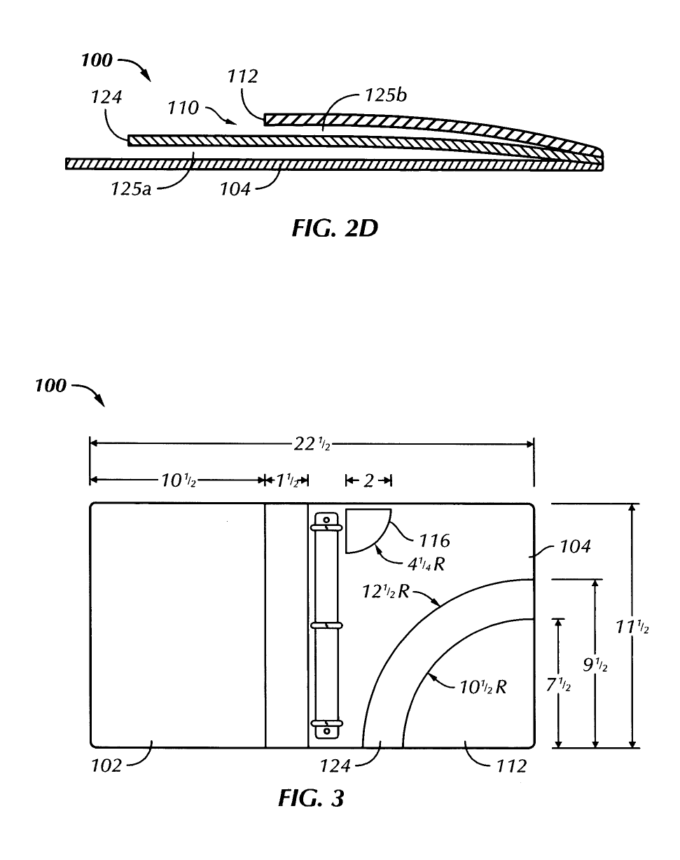

Referring to the drawings, a sheet retaining device such as a binder 100 is illustrated in FIGS. 1 and 2. According to a number of embodiments, the binder 100 (for example, a ring binder) may include front and back covers 102 and 104 and a spine 106. A binding mechanism 108 may be disposed on or near the spine 106. For example, in the embodiment shown, the binding mechanism 108 is attached to the back cover 104 adjacent to the spine 106. According to some of the embodiments, either one or both of the covers 102 and 104 may include a pocket 110.

The pocket 110 may include a primary flap 112 configured to retain a sheet of material such as paper. As shown, the flap 112 may be connected to the cover 104 along adjacent edges of the cover 104 (i.e., an outer edge 109 and a bottom edge 111) meeting at a corner 114. The pocket 110 may also include a secondary flap 116 disposed at a corner 118 that is diagonal to the primary corner 114. The secondary flap 116 may extend a distance along adjacent edges of the cover 104 (i.e., a top edge 113 and an inside edge 115). The flaps 112 and 116 may be welded, glued, or otherwise attached, either continuously or discontinuously, to the cover 104 according to known techniques in the art.

Accordingly, when a piece of sheet material 120 is received in the pocket 110, the secondary flap 116 serves as a corner lock for a free corner of the sheet of material 120 as illustrated in FIG. 2A. By retaining the free corner, the secondary flap 116 prevents the sheet material from dislodging from the pocket 110 even if the folder 100 were positioned upside down or sideways.

The binder 100 or the pocket 110 thereof may include a tertiary flap 117 as shown in FIG. 2B disposed at a third corner 122 of the cover 104. For the purposes of this description, the secondary flap 116 and the tertiary flap 117 may be respectively referred to as a “primary corner lock” and a “secondary corner lock.”

As shown in FIG. 2C, any of the flaps may be configured as a strip 119 extending substantially between adjacent orthogonal sides of the binder 100. The strip 119 functions in substantially the same manner as the flaps in that a free corner of a piece of paper 120 may be retained thereby. In addition to the secondary flaps 116 and 117, the primary flap 112 may also be configured as a strip in any number of embodiments.

In addition, the pocket 110 may include a second primary flap 124 that may be similarly configured as the first primary flap 112 except being larger in size, as shown in FIG. 2D. The second primary flap 124 may also be connected to the back cover 104 along the outer and bottom edges 109 and 111, with the second primary flap 124 being nested or sandwiched between the back cover 104 and the first primary flap 112. Accordingly, two sleeves 125a and 125b may be defined by the two primary flaps 112 and 124, with the secondary flap or corner lock 116 retaining the free corner of sheet material retained in the sleeves 125.

As shown in the example of a binder 100 in FIG. 3, the first primary flap 112 may extend about 7 inches or so along the sides of the cover 104; the second primary flap 124 about 9 inches; and the secondary flap or corner lock 116 about 2 inches along its respective sides of the cover 104. The dimensions are shown in FIG. 3 as an example of a particular commercial embodiment only and are not intended to be limiting in any way.

With reference to FIGS. 1 and 2A, each of the covers 102 and 104 may be described as having an internal surface 126 and an external surface 127. Any one or all of the flaps 112, 116, 124 may be in the form of sheet material that is welded to either of the surfaces 126, 127 of the covers 102, 104. For example, as particularly shown in FIG. 2A, the secondary flap 116 may be welded along weld lines 128 and 129 to the internal surface 126 of the back cover 104. According to embodiments as represented in FIG. 2, a primary flap 112 and a secondary flap 116 may also be attached, connected, or disposed on the internal surface 126 of the front cover 102 as well.

The first and second primary flaps 112 and 124 may have any type of configuration, for example, rectilinear or curvilinear, such as the arcuate configuration shown in FIG. 2. In the embodiment shown in FIG. 2A, the secondary flap 116 has a curvilinear configuration, although any configuration may be implemented. In some of the embodiments, at least a portion 131 of the flap 116 may extends outwardly from the corner 118 beyond a diagonal line indicated by phantom line D extending between the ends of the weld lines 128 and 129. This extended portion 131 may be lifted up to facilitate the insertion of sheet material under the flap 116.

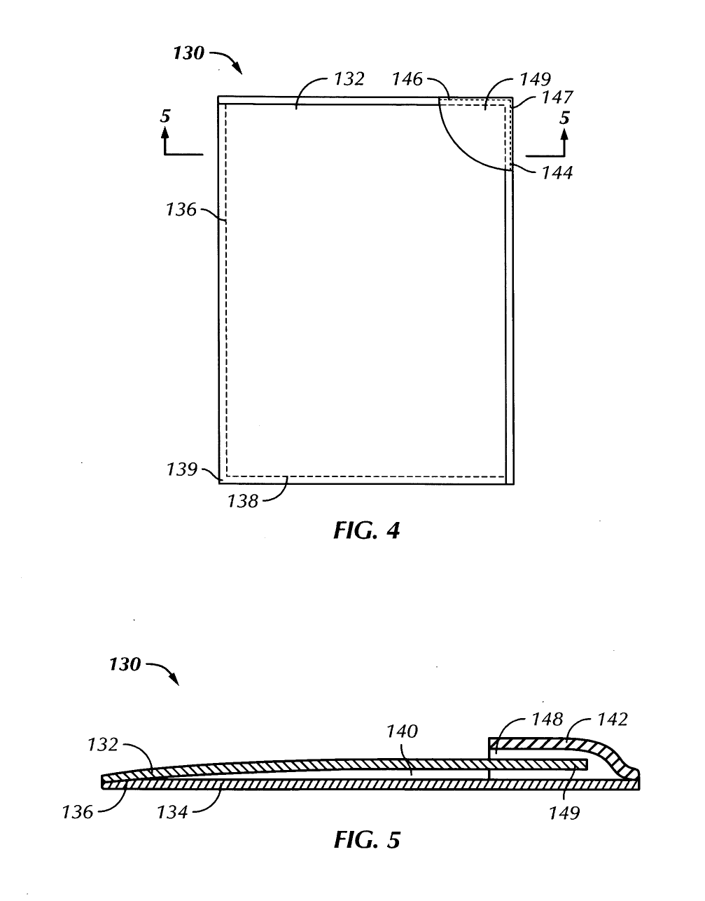

Referring to FIGS. 4 and 5, a sheet protector 130 includes a front sheet 132 and a back sheet 134 connected together along welds 136 and 138 along two adjacent orthogonal sides meeting at a first corner 139 to define a large pocket 140 for receiving sheet material. In a number of embodiments, the sheet protector 130 may include a flap 142 connected to the back sheet 134 along welds 144 and 146 along two adjacent orthogonal sides meeting at a second corner 147 to define a small pocket 148, with the second corner 147 being diagonal from the first corner 139. A free corner 149 of the front sheet 132 that is diagonal from the first corner 139 may then be received within the small pocket 148 and retained by the flap 142. Accordingly, the flap 142 may serve as a cover lock for the cover sheet 132 and any sheet material within the large pocket 140.

In an alternate embodiment, the welds 144 and 146 do not have to meet at the corner 147, leaving an opening at the corner 147 of the small pocket 148. In a further embodiment, the flap 142 does not include a portion that meets the corner 147, essentially forming a strip or strap with welds at 144 and 146 analogous to the strip 119 of FIG. 2C.

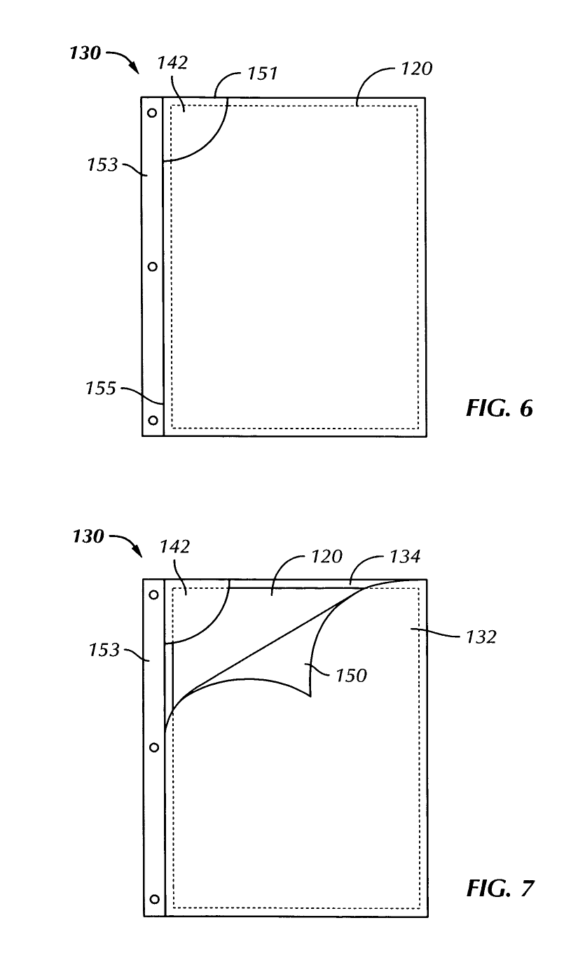

FIGS. 6 and 7 illustrate another embodiment of a sheet protector 130. In this embodiment, the flap 142 may be disposed along a top edge 151 and a margin 153 defined along a side edge 155 of the sheets 132 and 134. Accordingly, when the front sheet 132 is disengaged from the flap 142 and folded back as shown in FIG. 7, a piece of sheet material 120 may still be retained by the flap or corner lock 142. As an alternative to welds, the sheets 132 and 134 may be formed by folding a larger sheet of material such that the sheets 132 and 134 are integral along one edge.

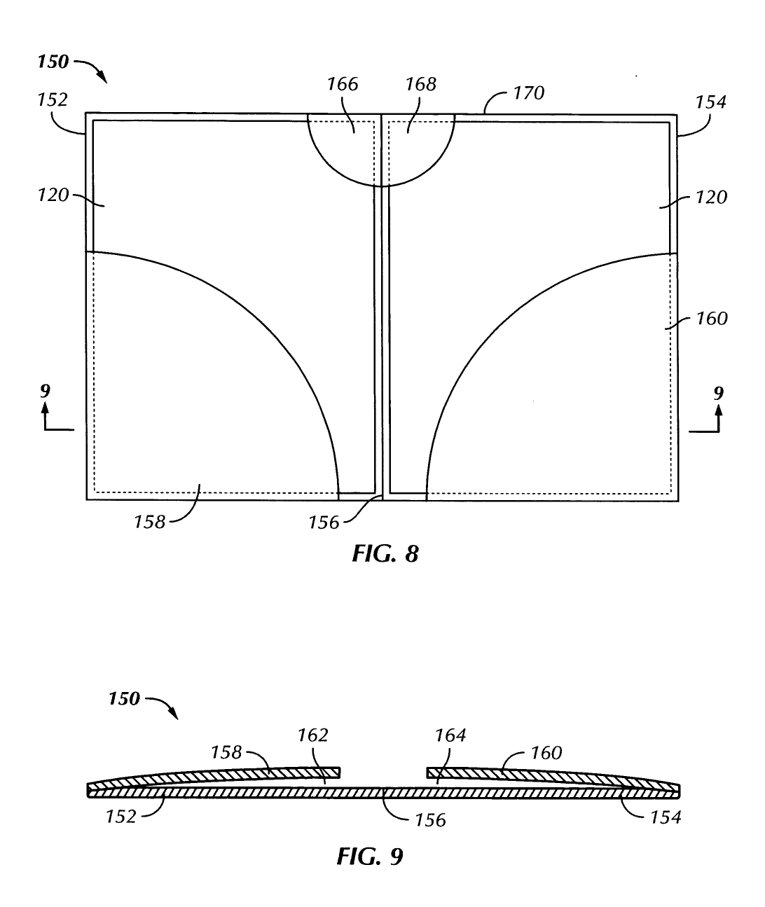

FIGS. 8 and 9 illustrate a number of embodiments of a folder 150. The folder 150 includes a front cover 152 and a back cover 154 with a fold or hinge line 156 defined therebetween. Each of the covers 152 and 154 may include a primary flap 158 and 160, respectively, with each flap respectively defining a pocket 162 and 164. Accordingly, each of the pockets 162 and 164 may retain one or more pieces of sheet material 120. In addition, each of the covers 152 and 154 may include a secondary flap 166 and 168, respectively, attached at or near the fold line 156 along a top edge 170 of the folder 150. The secondary flaps 166 and 168 function as corner locks for the sheet material 120. Additional corner locks may be provided analogous to that shown in FIG. 2B.

In view of the embodiments shown and described herein, the binder 100, the sheet protector 130, and the folder 150 may be generally referred to as a sheet retaining device. In any of the embodiments, the flaps and front sheets may include clear or transparent material so that the retained sheet material may be visible when retained in the pocket or sleeve. Alternatively, the flaps may include colored material for other aesthetic purposes.

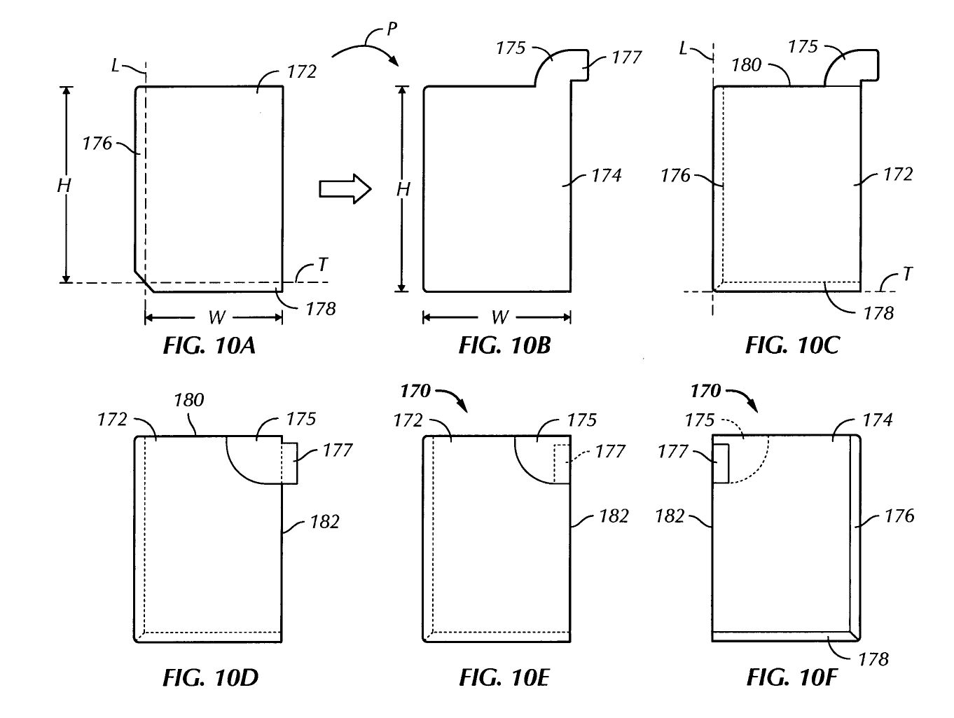

Methodology for manufacturing a sheet protector 170 according to some of the embodiments is illustrated in FIGS. 10A to 10F. As shown in FIGS. 10A and 10B, a front sheet 172 and a back sheet 174 may be cut from a suitable sheet material, such as paper or polypropylene. The back sheet 174 has an integral or unitary flap element 175 with a tab 177.

The back sheet 174 has a width W and a height H that are less than the overall dimensions of the front sheet 172 such that the front sheet 172 has a longitudinal margin 176 and a transverse margin 178 defined along a longitudinal fold line L and a transverse fold line T, respectively. Accordingly, when the front sheet 172 is positioned against the back sheet 174 as shown by arrow P, the margins 176 and 178 may be folded about the fold lines L and T, respectively, to wrap around edges of the back sheet 174, as shown in FIG. 10C. The margins 176 and 178 may then be attached to the back sheet 174, for example, by spot welding.

The flap element 175 may then be folded over a top edge 180 of the front sheet 172 as shown in FIG. 10D, and the tab 177 of the flap element 175 may then be folded over a side edge 182 to abut the back sheet 174 as shown in FIGS. 10E and 10F. The tab 177 may then be attached to the back sheet 174, for example, by spot welding.

Those skilled in the art will understand that the preceding embodiments of the present invention provide the foundation for numerous alternatives and modifications thereto. These other modifications are also within the scope of the present invention. Accordingly, the present invention is not limited to that precisely as shown and described in the present invention.

What is claimed is:

1. A binder comprising:
a pair of covers each having a top edge, a bottom edge, an outer edge, and an inner edge;
a first primary flap connected to one of the covers only along two intersecting edges thereof to form a pocket that is adapted to retain a piece of sheet material; and
an opposing secondary flap connected to the same cover as the primary flap along the other two intersecting edges thereof and is adapted to accept a corner of a piece of sheet material located in the pocket.

2. The binder of claim 1 further comprising a second primary flap connected along the same two intersecting edges of the first primary flap, with the second primary flap being positioned between the cover and the other primary flap, thereby defining a pair of pockets each adapted to receive a piece of sheet material.

3. The binder of claim 2 wherein the second primary flap is larger in size than the first primary flap.

4. The binder of claim 3 wherein the primary flaps are curvilinear in configuration.

5. The binder of claim 1 further comprising a tertiary flap disposed at along another two intersecting edges of the same cover to form a pocket that is adapted to accept a corner of a piece of sheet material retained in the pocket.

6. The binder of claim 1 further comprising a spine disposed between the covers and a binding mechanism disposed at or near the spine.

7. The binder of claim 1 wherein the primary flap includes transparent material.

8. The binder of claim 1 wherein:
each of the covers has an internal surface and an external surface;
the primary flap is connected to one of the covers only along the outer edge and the bottom edge thereof to form the pocket that is adapted to retain a piece of sheet material; and
the secondary flap is connected to the same cover as the primary flap along the inner edge and the top edge thereof.

9. The binder of claim 8 wherein the primary flap and the secondary flap are located on the internal surface of one of the covers.

10. The binder of claim 1 further comprising another primary flap and another secondary flap located on the other cover of the binder.

11. The binder of claim 1 wherein the secondary flap is configured as a strip extending substantially between adjacent orthogonal edges of the cover.

12. The binder of claim 1 wherein the secondary flap is configured as a strip extending substantially between adjacent orthogonal edges of the cover.

13. A sheet retaining device comprising:
a front cover and a back cover, each of the covers having a top edge, a bottom edge, an outer edge, and an inner edge;
a first primary flap connected to the back cover along the outer edge and the bottom edge thereof;
a second primary flap connected to the back cover along the outer edge and the bottom edge and positioned between the first primary flap and the back cover to form a pair of sleeves each adapted to retain a piece of sheet material; and
a secondary flap connected to the back cover along the inner edge and the top edge thereof to form a corner lock that is adapted to retain corner of sheet material retained in the sleeves.

14. The sheet retaining device of claim 13 wherein the second primary flap is larger in size than the first primary flap.

15. The sheet retaining device of claim 14 wherein the primary flaps are curvilinear in configuration.

16. The sheet retaining device of claim 13 further comprising a spine disposed between the covers and a binding mechanism disposed at the spine.

17. The sheet retaining device of claim 13 wherein the flaps are welded to the covers.

18. The sheet retaining device of claim 13 wherein the flaps include transparent material.

19. The sheet retaining device of claim 13 wherein the secondary flap is configured as a strip extending substantially between adjacent orthogonal edges of the cover.

20. The sheet retaining device of claim 13 wherein the sheet retaining device is a binder.
